(19) United States
(12) Patent Application Publication
(10) Pub. No.: US 2015/0081913 A1
(43) Pub. Date: Mar. 19, 2015

(54) Dynamic Load Management of Resources in a Cloud

(71) Applicant: SIEMENS AKTIENGESELLSCHAFT, München (DE)

(72) Inventors: Uwe Hohenstein, Vaterstetten (DE); Michael Jäger, Munchen (DE); Anna-Sophie Schwanengel, Munchen (DE)

(21) Appl. No.: 14/394,636

(22) PCT Filed: Mar. 19, 2013
(86) PCT No.: PCT/EP2013/055632

§ 371 Date: Oct. 15, 2014

(30) Foreign Application Priority Data
Apr. 16, 2012 (DE) 10 2012 206 177.0
Jun. 28, 2012 (DE) 10 2012 211 155.7

(51) Int. Cl. H04L 12/911

(52) U.S. Cl. CPC H04L 47/726
USPC 709/226

(57) ABSTRACT

The embodiments relate to a method for the dynamic load management of computational capacities in a cloud, the method including determining a currently-available computational capacity of the cloud, a currently-required computational load of the cloud, and an expected computational load of the cloud. The method further includes calculating a load threshold value for a connectible computational capacity for the cloud as a function of the available computational capacity, the currently-required computational load, and the expected computational load. The method further includes calculating a load parameter corresponding to an achieved data-processing performance of the cloud. The method further includes requesting the connectible computational capacity for the cloud on the basis of the calculated load threshold value and the load parameter of the cloud, in order to dynamically manage the load of the computational capacities in the cloud.

### CROSS-REFERENCE TO RELATED APPLICATIONS

The present patent document is a §371 nationalization of PCT Application Serial Number PCT/EP2013/055632, filed Mar. 19, 2013, designating the United States, which is hereby incorporated by reference, and this patent document also claims the benefit of DE 10 2012 206 177.0, filed on Apr. 16, 2012, and DE 10 2012 211 155.7, filed on Jun. 28, 2012, which are also hereby incorporated by reference.

### TECHNICAL FIELD

The present embodiments relate to a method for the dynamic load management of resources in a cloud and to a corresponding device.

### BACKGROUND

Modern computer applications are being operated more and more frequently in a so-called cloud. In this context, reference is also made to cloud computing.

The cloud computing approach describes the approach of providing abstracted IT infrastructures with respect to the computing capacity, the data storage volume and the network capacities in a manner dynamically configured to the requirements via a network. From the user's point of view, the abstracted IT infrastructure provided appears to be remote and opaque, as if shrouded in a “cloud.”

In this case, an application is operated in a cloud using defined technical interfaces and protocols.

In a cloud, the hardware is therefore not operated or provided by the user of an application himself. Rather, abstracted hardware is rented from one or more cloud providers as a service that may also be geographically remote.

The applications and data for the user are then no longer on the local computer, but rather in the so-called cloud.

The cloud may be accessed via a network, (e.g., the Internet). A cloud may also be operated, for instance, by a company, as a so-called private cloud in which the abstracted IT infrastructure is provided via a network, (e.g., an intranet, belonging to the company).

In a cloud, the number of resources, (e.g., memory or computing power), appears to be almost unlimited since these resources may be requested or subsequently requested in virtually any desired manner as required at any time. Cloud providers provide corresponding payment models in which often only the requested resources are paid for and no up-front investment in hardware or resources are made.

The resources required by a cloud application may be ordered or requested in this case from the cloud operator by the application operator in order to react to changed load situations.

For this purpose, modern cloud computing platforms may make it possible to set the quantity of required resources via a resource setting interface on a corresponding portal, for instance an Internet portal in the form of a website. In this case, the request for the resources is a manual activity and is the responsibility of the operator of the respective cloud application.

Furthermore, user requests may first of all be processed in a private IT structure and a connected external cloud computing platform in which additional virtual machines may be provided may be used in the event of overload situations in the home IT infrastructure. This request for the additional virtual machines is carried out manually in this case, as already described above.

Modern systems make it possible to monitor the performance of an application executed in a cloud. In this case, different characteristic numbers may be used, for instance. In this case, one possible characteristic number may provide information on whether problems will occur in the near future, and a further characteristic number makes it possible to infer an already existing overload. For example, the first characteristic number may be the quantity of requests in a queue, long processing times for requests, maximum CPU utilization and few execution operations per second or the like. In this case, the second characteristic number may be the number of applications or processes to be restarted.

U.S. Patent Publication No. 2012/0072597 A1 describes such a method in which the evaluation of the current system performance data and the corresponding resource management are carried out manually.

An approach that is often pursued involves, on the one hand, creating an accurate prediction and, on the other hand, making a new request at a further time or for a further threshold value. Making a new request has the disadvantage that the request may take 15 to 30 minutes to connect a server application and a certain lead time is therefore required.

Another adverse effect of requesting further resources when a threshold value is exceeded is that it is not possible to predict the actual future load in cloud computing offers.

In comparison with existing approaches from grid computing in which so-called jobs may be inserted into a queue, with the result that the number of jobs is known and may be requested at a given time, the load is unknown, on the one hand, and the resources are virtually unlimited, on the other hand, in cloud computing.

### SUMMARY AND DESCRIPTION

The scope of the present invention is defined solely by the appended claims and is not affected to any degree by the statements within this summary. The present embodiments may obviate one or more of the drawbacks or limitations in the related art.

An object of the present embodiments is to provide a possible way of efficiently operating a cloud.

The embodiments relate to a method for the dynamic load management of computing capacities in a cloud, including the following acts: (1) detecting a currently available computing capacity of the cloud, a currently required computing load of the cloud, and an expected computing load of the cloud; (2) calculating a load threshold value for a connectable computing capacity for the cloud on the basis of the available computing capacity, the currently required computing load, and the expected computing load; (3) calculating a load parameter corresponding to an achieved data processing performance of the cloud; and (4) requesting the connectable computing capacity for the cloud on the basis of the calculated load threshold value and the load parameter of the cloud for the dynamic load management of the computing capacities in the cloud.

According to another aspect, a device is provided for the dynamic load management of computing capacities in a cloud.

In this case, the device includes a detection device that is configured to detect a currently available computing capacity of the cloud, a currently required computing load of the cloud, and an expected computing load of the cloud. The device further includes a computing device that is configured to (1) calculate a load threshold value for a connectable computing capacity for the cloud on the basis of the available computing capacity, the currently required computing load, and the expected computing load and (2) calculate a load parameter corresponding to an achieved data processing performance of the cloud. The device further includes a requesting device that is configured to request the connectable computing capacity for the cloud on the basis of the calculated load threshold value and the load parameter of the cloud for the dynamic load management of the computing capacities in the cloud.

A method for the dynamic load management of computing capacities in a cloud may be provided, where the method may be used for a public cloud or a private cloud or a hybrid cloud with combined access to abstracted IT infrastructures from the areas of public clouds and private clouds.

Another advantage is that the method may also be used for the dynamic load management of computing capacities when operating computing resources in computing centers.

The insight on which the present embodiments are based is that a resource requirement of a cloud may be determined using different data and corresponding resources may be efficiently requested and used.

The advantage of the present embodiments are that the operator of the server application need not have available the entire capacity, but rather additionally selectively requests rentable capacity for this purpose from a provider, if necessary.

For this purpose, the present embodiments provide for determining whether further capacities are requested and determining how much capacity is requested.

For cloud bursting, the request for additional capacities and the renting of the capacities from a provider may be associated with costs and additional energy consumption. The decision criterion is therefore that of keeping the costs and the energy consumption low. Added to this, as a further boundary condition, is the fact that resource requests in cloud computing or in a web service may not be complied with at any price and may not always be complied with promptly.

The embodiments propose an assessment mechanism that makes the decision on cloud bursting, that is to say decides whether a request is carried out and to what extent.

The present embodiments therefore make it possible to operate a cloud in a very efficient and energy-saving manner and to provide or consult only those resources that are actually required and therefore reduce the energy consumption of the cloud. As a result, the operation of the cloud or an application in the cloud becomes very energy-efficient. Furthermore, the costs for the operator of a cloud or an application in the cloud may be reduced.

One possible embodiment of the method provides for minimization of the connectable computing capacity to be used as a decision criterion for requesting the connectable computing capacity for the cloud.

Another possible embodiment of the method provides for an energy consumption of the cloud to be reduced by minimizing the connectable computing capacity.

Another possible embodiment of the method provides for compliance with resource requests to the cloud to be used as a decision criterion for requesting the connectable computing capacity for the cloud.

Another possible embodiment of the method provides for at least one probability parameter for the expected computing load to be used as a decision criterion for requesting the connectable computing capacity for the cloud.

Another possible embodiment of the method provides for at least one probability parameter for the load parameter to be used as a decision criterion for requesting the connectable computing capacity for the cloud.

Another possible embodiment of the method provides for a useful parameter that describes a benefit achieved by the achieved data processing performance of the cloud to be used as a decision criterion for requesting the connectable computing capacity for the cloud.

Another possible embodiment of the device provides for the requesting device to also be configured to use minimization of the connectable computing capacity as a decision criterion for requesting the connectable computing capacity for the cloud.

Another possible embodiment of the device provides for the requesting device to also be configured to reduce an energy consumption of the cloud by minimizing the connectable computing capacity.

Another possible embodiment of the device provides for the requesting device to also be configured to use compliance with resource requests to the cloud as a decision criterion for requesting the connectable computing capacity for the cloud.

Another possible embodiment of the device provides for the requesting device to also be configured to use at least one probability parameter for the expected computing load as a decision criterion for requesting the connectable computing capacity for the cloud.

Another possible embodiment of the device provides for the requesting device to also be configured to use at least one probability parameter for the load parameter as a decision criterion for requesting the connectable computing capacity for the cloud.

Another possible embodiment of the device provides for the requesting device to also be configured to use a useful parameter as a decision criterion for requesting the connectable computing capacity for the cloud.

If useful, the above refinements and developments may be combined with one another in any desired manner.

Further possible refinements, developments and implementations also include combinations (not explicitly mentioned) of features described above or below with respect to the exemplary embodiments. In particular, a person skilled in the art will also add individual aspects in this case as improvements or additions to the respective basic form.

### BRIEF DESCRIPTION OF THE DRAWINGS

FIG. 1 depicts a flowchart of a method for the dynamic load management of resources in a cloud according to one possible embodiment of the method.

FIG. 2 depicts a block diagram of a cloud according to one possible embodiment of the device.

FIG. 3 depicts a block diagram of a device for the dynamic load management of resources in a cloud according to one possible embodiment of the device.

FIG. 4 depicts a graph with an illustration of a probability distribution according to one possible embodiment of the method.

In all figures, identical or functionally identical elements and devices have been provided with the same reference symbols, unless indicated otherwise.

### DETAILED DESCRIPTION

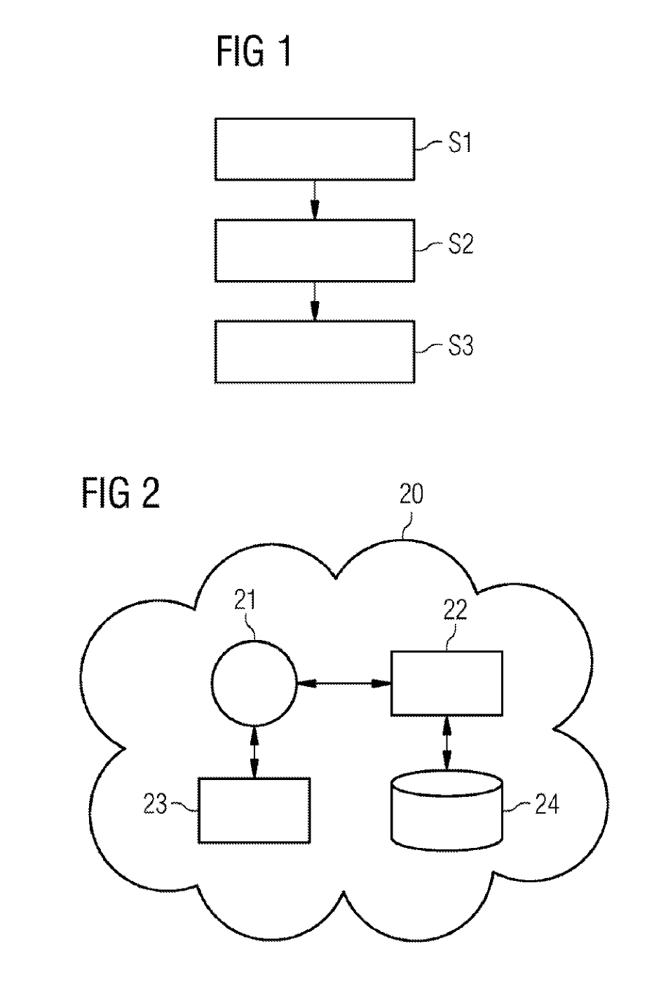

FIG. 1 depicts a flowchart of a method for the dynamic load management of resources in a cloud according to one possible embodiment of the method.

In one act, a currently available computing capacity of the cloud 20, a currently required computing load of the cloud 20, and an expected computing load of the cloud 20 are detected S1.

In a further act, a load threshold value for a connectable computing capacity for the cloud 20 is calculated S2 on the basis of the available computing capacity, the currently required computing load and the expected computing load.

In a further act, a load parameter corresponding to an achieved data processing performance of the cloud 20 is calculated.

In a further act, the connectable computing capacity for the cloud 20 is requested S3 on the basis of the calculated load threshold value and the load parameter of the cloud 20 for the dynamic load management of the computing capacities in the cloud 20.

FIG. 2 depicts a block diagram of a cloud according to one possible embodiment of the device.

A cloud 20 of any desired structure of a cloud architecture according to one possible embodiment of the device includes a cloud service device 21, a cloud platform device 22, a cloud infrastructure device 23, and a cloud data storage device 24.

The cloud service device 21 provides particular services for the user of the cloud 20. In this case, the cloud platform device 22 makes it possible to execute applications for the services, for example.

The cloud infrastructure device 23 may be used for accounting and billing services of the cloud 20. The cloud data storage device 24 may be used as a virtual data store of the cloud 20.

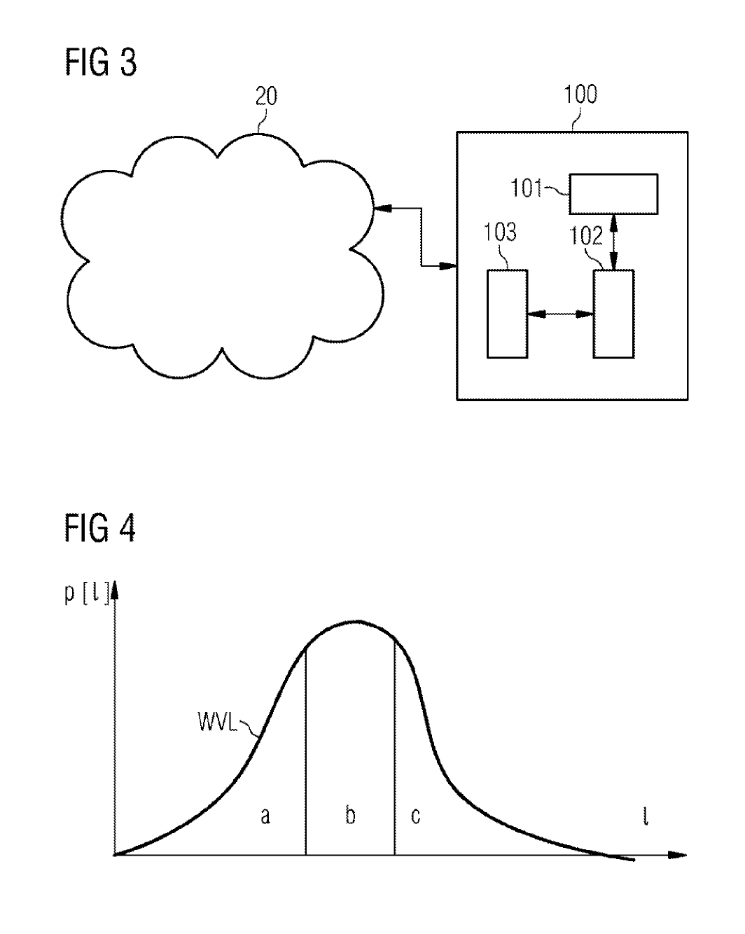

FIG. 3 depicts a block diagram of a device for the dynamic load management of resources in a cloud according to one possible embodiment of the device.

A device 100 includes a detection device 101, a computing device 102, and a requesting device 103. In this case, the detection device 101, the computing device 102, and the requesting device 103 are in the form, for example, of technical devices that are connected as a network.

The detection device 101 is configured to detect a currently available computing capacity of the cloud 20, a currently required computing load of the cloud 20, and an expected computing load of the cloud 20.

The computing device 102 is configured to calculate a load threshold value for a connectable computing capacity for the cloud 20 on the basis of the available computing capacity, the currently required computing load, and the expected computing load. The computing device 102 is also configured to calculate a load parameter corresponding to an achieved data processing performance of the cloud 20.

The requesting device 103 is configured to request the connectable computing capacity for the cloud 20 on the basis of the calculated load threshold value and the load parameter of the cloud 20 for the dynamic load management of the computing capacities in the cloud 20.

FIG. 4 depicts a graph with an illustration of a probability distribution according to one possible embodiment of the method.

A relative probability p is plotted on the y axis of the graph depicted in FIG. 4 and a random variable 1 is plotted on the x axis.

The probability distribution WVL in FIG. 4 depicts a first area a in which too little load has been determined, a second area b in which the load has been correctly determined, and a third area c in which too much load has been determined.

The method for dynamic load management may carry out controlled waiver of the compliance with the requested computing capacity by agreed failure contingents and may use a rental model when using resources. In this case, resources are dynamically connected with a delay to be taken into account as a result of a case analysis.

The case analysis results in a comparative analysis of different solution configurations. The main solution classes are determined during this analysis. An additional act may be carried out on the basis of numerical methods for an input configuration with linear parameters with full coverage of the range of possibilities.

In order to rent servers, a distinction is made between the following main solution approaches for comparing the possible loss: rent no servers, rent fewer servers than predicted, rent as many servers as predicted and rent too many servers.

In this case, K denotes costs of renting servers, W denotes a probability of occurrence, U denotes a turnover as a result of additional handling of an outlay and U denotes an achieved surplus.

In this case:

U−K=Ü.

For the following first consideration example, a situation is assumed in which a provider sells a service and has a very small margin in this case. The first consideration example assumes a uniform distribution of the probabilities for the assessment; however, another distribution of the probabilities is likewise possible. The following are used as fictitious numbers: costs K of $90, revenue of $100, and a surplus of $10. Furthermore, the probability W for “too little load” or “too much load” is 50%.

The following losses therefore result for the first situation in which renting is carried out: a loss of $90 if the expected load is absent; a loss of $45 if the load is 50% smaller than capacity, a loss of $−10 and therefore a profit of $10 if the prediction is correct, and a loss of $−5 and therefore a profit of $5 if the load is 50% higher than capacity. This results in a total loss of $120 with the assumed uniform distribution.

Furthermore, the following losses result for the second situation in which cloud computing capacities are not rented: a loss of $0 if the expected load is absent; a loss of $5 if the load is 50% lower than capacity, a loss of $10 if the prediction is correct, and a loss of $15 if the load is 50% higher than capacity. This results in a total loss of $30.

The following losses result in the third situation in which only 50% of the unreliably predicted load is rented: a loss of $45 if the expected load is absent; a loss of $−5 and therefore profit of $5 if the load is 50% lower than capacity, a loss of $0 if the prediction is correct, and a loss of $5 if the load is 50% higher than capacity. This results in a total loss of $35.

In summary, in the first consideration example, the second situation “do not rent” with a loss of $30 is the best choice.

As a second consideration example, a situation is assumed in which a provider sells a service and in this case has a higher margin than in the first consideration example. The second consideration example also assumes a uniform distribution of the probabilities for the assessment. The following are used as fictitious numbers: costs K of $10, revenue of $100, and a surplus of $90. Furthermore, the probability W for “too little load” or “too much load” is 50%.

The following losses therefore result for the first situation in which renting is carried out: a loss of $10 if the expected load is absent; a loss of $45 if the load is 50% lower than capacity, a loss of $−90 and therefore a profit of $90 if the prediction is correct, and a loss of $−45 and therefore a profit of $45 if the load is 50% higher than capacity. This results in a total profit of $80.

Furthermore, the following losses result for the second situation in which cloud computing capacities are not rented: a loss of $0 if the expected load is absent; a loss of $45 if the load is 50% lower than capacity, a loss of $90 if the prediction is correct, and a loss of $135 if the load is 50% higher than capacity. This results in a total loss of $270.

The following losses result in the third situation in which only 50% of the unreliably predicted load is rented: a loss of $5 if the expected load is absent; a loss of $−45 and therefore a profit of $45 if the load is 50% lower than capacity, a loss of $0 if the prediction is correct, and a loss of $45 if the load is 50% higher than capacity. This results in a total loss of $5.

In summary, in the second consideration example, the first situation “rent” with a profit of $80 is the best choice.

The method for dynamic load management based on a case distinction therefore allows the cost/benefit ratio to be precisely estimated on the basis of the margin.

The consideration examples show that the method allows the loss to be exactly calculated on the basis of the margin under the given input parameters. Therefore, the corresponding decisions may be prioritized depending on the margin of the service and according to the predicted load. This is provided, in particular, if the values are numerically very close and estimation is therefore not possible.

Furthermore, the method for the dynamic load measurement of the resources in the cloud may also aim the estimation at a ratio of achieved computing load to a required use of energy instead of aiming the estimation at the difference between costs and benefits.

In this case, instead of the costs, the method for dynamic load management may estimate an energy requirement that is determined, (e.g., in kilowatt hours or in joules). Furthermore, instead of the turnover U, the method for dynamic load management may estimate an achieved computing load or an achieved computing power that represents a data processing performance, (e.g., in floating point operations per second or in another measure for the performance of computer systems). In this case, instead of the difference, a quotient of the two determined variables would then be formed and would be used as a load parameter of the method. Accordingly, load threshold values in the form of kilowatt hours per floating point operations per second may be used in this case.

An energy consumption EV may be used instead of the costs K, and a performance of an IT system as an achieved data processing performance may be used instead of the turnover U.

In this case, instead of a margin, it is also possible to minimize an energy consumption of the cloud 20 and a maximum achieved computing load may nevertheless have been processed by the cloud 20.

Although the present invention was described above using described exemplary embodiments, it is not restricted thereto but rather may be modified in various ways. In particular, the invention may be changed or modified in multifarious ways without departing from the essence of the invention.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for the dynamic load management of computing capacities in a cloud, the method comprising:
detecting a currently available computing capacity of the cloud, a currently required computing load of the cloud, and an expected computing load of the cloud;
calculating a load threshold value for a connectable computing capacity for the cloud based on the available computing capacity, the currently required computing load, and the expected computing load;
calculating a load parameter corresponding to an achieved data processing performance of the cloud; and
requesting the connectable computing capacity for the cloud based on the calculated load threshold value and the calculated load parameter of the cloud for the dynamic load management of the computing capacities in the cloud.

2. The method as claimed in claim 1, wherein minimization of the connectable computing capacity is used as a decision criterion for the requesting of the connectable computing capacity for the cloud.

3. The method as claimed in claim 2, wherein an energy consumption of the cloud is reduced by minimizing the connectable computing capacity.

4. The method as claimed claim 3, wherein compliance with resource requests to the cloud is used as a decision criterion for the requesting of the connectable computing capacity for the cloud.

5. The method as claimed in claim 1, wherein at least one probability parameter for the expected computing load is used as a decision criterion for the requesting of the connectable computing capacity for the cloud.

6. The method as claimed in claim 1, wherein at least one probability parameter for the load parameter is used as a decision criterion for the requesting of the connectable computing capacity for the cloud (20).

7. The method as claimed in claim 1, wherein a useful parameter that describes a benefit achieved by the achieved data processing performance of the cloud is used as a decision criterion for the requesting of the connectable computing capacity for the cloud.

8. A device for the dynamic load management of computing capacities in a cloud, the device comprising:
a detection device configured to detect a currently available computing capacity of the cloud, a currently required computing load of the cloud, and an expected computing load of the cloud;
a computing device configured to (1) calculate a load threshold value for a connectable computing capacity for the cloud on the basis of the available computing capacity, the currently required computing load, and the expected computing load, and (2) calculate a load parameter corresponding to an achieved data processing performance of the cloud; and
a requesting device configured to request the connectable computing capacity for the cloud on the basis of the calculated load threshold value and the calculated load parameter of the cloud for the dynamic load management of the computing capacities in the cloud.

9. The device as claimed in claim 8, wherein the requesting device is further configured to use minimization of the connectable computing capacity as a decision criterion for requesting the connectable computing capacity for the cloud.

10. The device as claimed in claim 9, wherein the requesting device is further configured to reduce an energy consumption of the cloud by minimizing the connectable computing capacity.

11. The device as claimed in claim 8, wherein the requesting device is further configured to use compliance with resource requests to the cloud as a decision criterion for requesting the connectable computing capacity for the cloud.

12. The device as claimed in claim 8, wherein the requesting device is further configured to use at least one probability parameter for the expected computing load as a decision criterion for requesting the connectable computing capacity for the cloud.

13. The device as claimed in claim 8, wherein the requesting device is further configured to use at least one probability parameter for the load parameter as a decision criterion for requesting the connectable computing capacity for the cloud.

14. The device as claimed in claim 8, wherein the requesting device is further configured to use a useful parameter as a decision criterion for requesting the connectable computing capacity for the cloud.

15. The method as claimed claim 1, wherein compliance with resource requests to the cloud is used as a decision criterion for the requesting of the connectable computing capacity for the cloud.

16. The device as claimed in claim 9, wherein the requesting device is further configured to use compliance with resource requests to the cloud as a decision criterion for requesting the connectable computing capacity for the cloud.

17. The device as claimed in claim 10, wherein the requesting device is further configured to use compliance with resource requests to the cloud as a decision criterion for requesting the connectable computing capacity for the cloud.

18. The device as claimed in claim 17, wherein the requesting device is further configured to use at least one probability parameter for the expected computing load as a decision criterion for requesting the connectable computing capacity for the cloud.

19. The device as claimed in claim 18, wherein the requesting device is further configured to use at least one probability parameter for the load parameter as a decision criterion for requesting the connectable computing capacity for the cloud.

20. The device as claimed in claim 17, wherein the requesting device is further configured to use a useful parameter as a decision criterion for requesting the connectable computing capacity for the cloud.
